(19) United States
(12) Patent Application Publication
(10) Pub. No.: US 2013/0289987 A1
(43) Pub. Date: Oct. 31, 2013

(54) Negative Example (Anti-Word) Based Performance Improvement For Speech Recognition

(71) Applicant: INTERACTIVE INTELLIGENCE, INC., Indianapolis, IN (US)

(72) Inventors: Aravind Ganapathiraju, Hyderabad (IN); Ananth Nagaraja Iyer, Carmel, IN (US); Felix Immanuel Wyss, Zionsville, IN (US)

(73) Assignee: Interactive Intelligence, Inc., Indianapolis, IN (US)

(21) Appl. No.: 13/871,053

(22) Filed: Apr. 26, 2013

Related U.S. Application Data
(60) Provisional application No. 61/639,242, filed on Apr. 27, 2012.

(51) Int. Cl. G10L 15/04

(52) U.S. Cl. CPC G10L 15/04
USPC 704/236

(57) ABSTRACT

A system and method are presented for negative example based performance improvements for speech recognition. The presently disclosed embodiments address identified false positives and the identification of negative examples of keywords in an Automatic Speech Recognition (ASR) system. Various methods may be used to identify negative examples of keywords. Such methods may include, for example, human listening and learning possible negative examples from a large domain specific text source. In at least one embodiment, negative examples of keywords may be used to improve the performance of an ASR system by reducing false positives.

### BACKGROUND

The presently disclosed embodiments generally relate to telecommunication systems and methods, as well as automatic speech recognition systems. More particularly, the presently disclosed embodiments pertain to negative example, or anti-word, based performance improvement for speech recognition within automatic speech recognition systems.

### SUMMARY

A system and method are presented for negative example based performance improvements for speech recognition. The presently disclosed embodiments address identified false positives and the identification of negative examples of keywords in an Automatic Speech Recognition (ASR) system. Various methods may be used to identify negative examples of keywords. Such methods may include, for example, human listening and learning possible negative examples from a large domain specific text source. In at least one embodiment, negative examples of keywords may be used to improve the performance of an ASR system by reducing false positives.

In one embodiment a method for using negative examples of words in a speech recognition system is described, the method comprising the steps of: defining a set of words; identifying a set of negative examples of said words; performing keyword recognition on said set of words and said set of negative examples; determining confidence values of words in said set of words; determining confidence values of words in said set of negative examples; identifying at least one candidate word from said set of words where said confidence value in said set of words meets a first criteria; comparing said confidence value of said at least one candidate word to said confidence value of at least one word in said set of negative examples of words; and accepting said at least one candidate word as a match if said comparing meets a second criteria.

In another embodiment, a method for using negative examples of words in a speech recognition system is described, the method comprising the steps of: defining a set of words; performing a first keyword recognition with said set of words; determining confidence values of words in said set of words; identifying at least one candidate word from said set of words where said confidence value of words in said set of words meets a first criteria; selecting a set of negative examples of said at least one candidate word; performing a second keyword recognition with said set of negative examples; determining confidence values of words in said set of negative examples; comparing said confidence value of said at least one candidate word to said confidence value of at least one word in id set of negative examples; and, accepting said at least one candidate word as a match if said comparing meets a second criteria.

In another embodiment a system for identifying negative examples of keywords is described, comprising: a means for detecting a keyword in an audio stream; a means for detecting a negative example of said keyword in an audio stream; a means for combining information from said detected keyword and detected negative examples of said keyword; and, a means for determining whether a detected word is a negative example of a keyword.

### BRIEF DESCRIPTION OF THE DRAWINGS

FIG. 1 is a diagram illustrating the basic components in one embodiment of a Keyword Spotter.

FIG. 2 is a flow chart illustrating one embodiment of a process for the identification of negative examples of keywords based on human listening.

FIG. 3 is a diagram illustrating one embodiment of a process for automatically determining negative examples of keywords suggestions.

FIG. 4 is a diagram illustrating one embodiment of a process for the use of negative examples of keywords.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Automatic Speech Recognition (ASR) systems analyze spoken words and statistically match speech to models of speech units. Performance of these systems is generally evaluated based on the accuracy and the speed with which speech can be recognized. Many factors can have an effect on the accuracy of an ASR system. These factors may include accent, articulation, rate of speech, pronunciation, background noise, etc.

An example of an ASR system may include a Keyword Spotter. In a Keyword Spotter, only specific predefined words and phrases may be recognized in an audio stream. However, performance of a Keyword Spotter may be affected by detections and false positives. Detection may occur when the Keyword Spotter locates a specified keyword in an audio stream when it is spoken. A false positive may be a type of error that occurs when the Keyword Spotter locates a specified keyword that has not been uttered in an audio stream. The Keyword Spotter may have confused the specified keyword to another word or word fragment that was uttered. Ideally, a Keyword Spotter will perform with a high detection rate and a low false positive rate. Anti-words, or negative examples of keywords, may be defined as words that are commonly confused for a particular keyword. The identification of anti-words may be used to improve speech recognition systems, specifically in keyword spotting and, generally, in any other forms of speech recognition by reducing false positives.

In one embodiment, the false positives identified by a Keyword Spotter in an ASR system and the identification of anti-words are addressed. For example, in an ASR system that is specific to a stock brokerage domain, the keyword “share” may be specified in the system. The utterance of the word “chair” by a speaker may result in a high probability that the system will falsely recognize the word “share”. If this error occurs predictably, then the system can be made aware of this confusion between the keyword “share” and a word, such as “chair”. The detection of the word “chair” may indicate to the system to not hypothesize the word “share” as a result. The word “chair” becomes a negative example, or an anti-word, for the word “share”. Alternatively, if the ASR system is specific to the domain of a furniture store, the utterance of the word “share” may cause a Keyword Spotter to incorrectly hypothesize the keyword “chair”. Thus, “share” would become the anti-word of the word “chair”.

In another embodiment, any type of speech recognition system may be tuned using a similar method to that of a Keyword Spotter. For example, a grammar based speech recognition system may incorrectly recognize the word “Dial” whenever a user speaks the phrase “call Diane”. The system then may display an increased probability that the word “Dial” is triggered when “Diane” or another similar word is spoken. “Diane” could thus be identified as an anti-word for “Dial”.

The identification of accurate anti-words is integral to at least one embodiment in order to reduce false positives. Several methods may be used for the identification of anti-words. One such method may use expert human knowledge to suggest anti-words based on the analysis of results from large-scale experiments. The expert compiles lists through human understanding of confusing words based on the results shown from existing experiments where words are shown to be mistaken for each other. While this method is considered very effective, it can be tedious, expensive and assumes the availability of human subject matter experts, large quantities of data to analyze and significant amount of time for processing this data to build a library of anti-words.

In another embodiment, an automated anti-word suggestion mechanism that alleviates the aforementioned need for availability of time and resources may be used. For example, a search is performed through a large word-to-pronunciation dictionary in a specified language for words and phrases that closely match a given keyword using several available metrics. A shortlist of such confusable words may be presented to the user to choose from at the time of specifying a keyword.

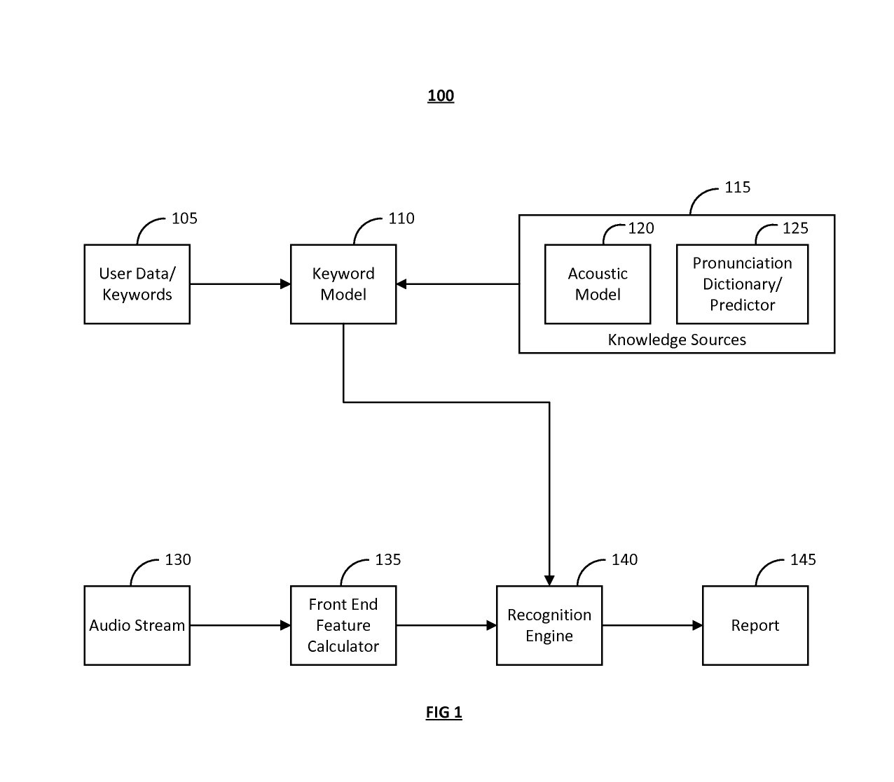

FIG. 1 is a diagram illustrating the basic components in one embodiment of a Keyword Spotter indicated generally at 100. The basic components of a Keyword Spotter 100 may include: User Data/Keywords 105; a Keyword Model 110; Knowledge Sources 115, which may include an Acoustic Model 120 and a Pronunciation Dictionary/Predictor 125; an Audio Stream 130; a Front End Feature Calculator 135; a Recognition Engine (Pattern Matching) 140; and Reported Results 145.

User Data/Keywords 105 may be defined by the user of the system according to user preference. The Keyword Model 110 may be composed based on the User Data/Keywords 105 that are defined by the user and the input to the Keyword Model 110 based on Knowledge Sources 115. Such knowledge sources may include an Acoustic Model 120 and a Pronunciation Dictionary/Predictor 125.

A phoneme may be assumed to be the basic unit of sound. A predefined set of such phonemes may be assumed to completely describe all sounds of a particular language. The Knowledge Sources 115 may store probabilistic models, for example, hidden Markov model-Gaussian mixture model (HMM-GMM), of relations between pronunciations (phonemes) and acoustic events, such as a sequence of feature vectors extracted from the speech signal. A hidden Markov model (HMM) may encode the relationship of the observed audio signal and the unobserved phonemes. A training process may then study the statistical properties of the feature vectors emitted by an HMM state corresponding to a given phoneme over a large collection of transcribed training data. An emission probability density for the feature vector in a given HMM state of a phoneme may be learned through the training process. This process may also be referred to as acoustic model training. Training may also be performed for a triphone. An example of a triphone may be a tuple of three phonemes in the phonetic transcription sequence corresponding to a center phone. Several HMM states of triphones are tied together to share a common emission probability density function. Typically, the emission probability density function is modeled using a Gaussian mixture model (GMM). A set of these GMMs and HMMs is termed as an acoustic model.

The Knowledge Sources 115 may be developed by analyzing large quantities of audio data. The Acoustic Model 120 and the Pronunciation Dictionary/Predictor 125 are made, for example, by examining a word such as “hello” and the phonemes that comprise the word. Every keyword in the system may be represented by a statistical model of its constituent sub-word units called the phonemes. The phonemes for “hello” as defined in a standard phoneme dictionary are: “hh”, “eh” “l”, and “ow”. These are then converted to a sequence of triphones, for example, “sil−hh+eh”, “hh−eh+l”, “eh−l+ow”, and “l−ow+sil”, where “sil” is the silence phoneme. Finally, as previously described, the HMM states of all possible triphones may be mapped to the tied-states. Tied-states are the unique states for which acoustic model training may be performed. These models may be language dependent. In order to also provide multi-lingual support, multiple knowledge sources may be provided.

The Acoustic Model 120 may be formed by statistically modeling the various sounds that occur in a particular language. The Pronunciation Dictionary 125 may be responsible for decomposing a word into a sequence of phonemes. For example, words presented from the user may be in a human readable form, such as grapheme/alphabets of a particular language. However, the pattern matching algorithm may rely on a sequence of phonemes which represent the pronunciation of the keyword. Once the sequence of phonemes is obtained, the corresponding statistical model for each of the phonemes in the acoustic model may be examined. A concatenation of these statistical models may be used to perform keyword spotting for the word of interest. For words that are not present in the dictionary, a predictor, which is based on linguistic rules, may be used to resolve the pronunciations.

The Audio Stream 130 may be fed into the Front End Feature Calculator 135 which may convert the Audio Stream 130 into a representation of the audio stream, or a sequence of spectral features. The Audio Stream 130 may be comprised of the words spoken into the system by the user. Audio analysis may be performed by computation of spectral features, for example, Mel Frequency Cepstral Coefficients (MFCC) and/or its transforms.

The Keyword Model 110, which may be formed by concatenating phoneme hidden Markov models (HMMs), and the signal from the Audio Stream, 130, may both then be fed into a Recognition Engine for pattern matching, 140. For example, the task of the Recognition Engine 140 may be to take a set of words, also referred to as a lexicon, and search through the presented audio stream 130 using the probabilities from the acoustic model 120 to determine the most likely sentence spoken in that audio signal. One example of a speech recognition engine may include, but not be limited to, a Keyword Spotting System. For example, in the multi-dimensional space constructed by the Feature Calculator 135, a spoken word may become a sequence of MFCC vectors forming a trajectory in the acoustic space. Keyword spotting may now become a problem of computing the probability of generating the trajectory given the keyword model. This operation may be achieved by using the well-known principle of dynamic programming, specifically the Viterbi algorithm, which aligns the keyword model to the best segment of the audio signal, and results in a match score. If the match score is significant, the keyword spotting algorithm may infer that the keyword was spoken and may thus report a keyword spotted event.

The resulting sequence of words may then be reported in real-time, 145. For example, the report may be presented as a start and end time of the keyword in the audio stream with a confidence value that the keyword was found. The primary confidence value may be a function of how the keyword is spoken. For example, in the case of multiple pronunciations of a single word, the keyword “tomato” may be spoken as “T OW M AA T OW” and “T OW M EY T OW”. The primary confidence value may be lower when the word is spoken in a less common pronunciation or when the word is not well enunciated. The specific variant of the pronunciation that is part of a particular recognition is also displayed in the report.

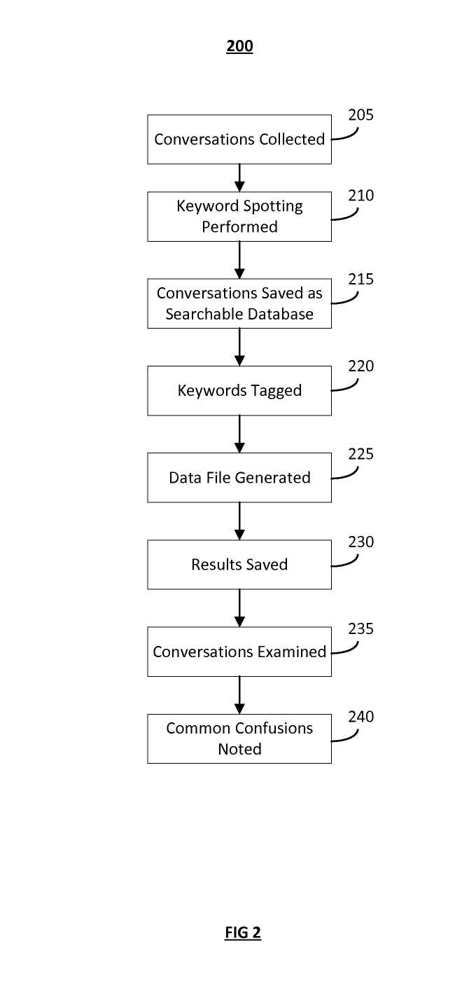

As illustrated in FIG. 2, one embodiment of a process 200 for the identification of negative examples of keywords based on human listening is provided. The process 200 may be operative in the system 100 (FIG. 1).

In operation 205, conversations are collected. For example, conversations may be collected from call centers or other system originations. Any number of conversations may be collected. In one embodiment, keyword spotting may be performed in real-time on these conversations at the time of their collection. Control is passed to operation 210 and process 200 continues.

In operation 210, keyword spotting is performed. For example, keyword spotting may be performed on the conversations saved as searchable databases to determine all instances in which the designated keyword appears within the collected conversations. Control is passed to operation 215 and process 200 continues.

In operation 215, conversations and the keywords found in the conversations are saved as a searchable database. For example, a recorder component may procure a conversation and save the conversation as a searchable database that can be searched for keywords. Control is passed to operation 220 and process 200 continues.

In operation 220, keywords are tagged within the recordings. For example, the conversations are tagged (or indexed) with keywords present. A tag may represent information on the location of where a keyword was spotted in an audio stream. A tag may also include other information such as the confidence of the system in the keyword spot and the actual phonetic pronunciation used for the keyword spot. Control is passed to operation 225 and process 200 continues.

In operation 225, a large data file is generated. For example, the system may string together the parts of the conversations that contain all instances of that particular keyword that was spotted. Control is passed to operation 230 and process 200 continues.

In operation 230, the results are saved. For example, the results of the keyword spotting are saved along with the original conversations and the key word spots. Control is passed to operation 235 and process 200 continues.

In operation 235, the conversations are examined. For example, the tagged conversations are examined by a human through listening. A person may then jump from one instance to the next using the tags that have been placed in order to start recognizing the patterns that are occurring within the conversations. Those conversations can be examined using the tags to determine the most common places that a key word is erroneously detected. For example, when the word “three thousand” is being spoken, the word “breakout” may be detected. This could be a result of the system confusing the sounds “three thou” with “break ou” from the words. Control is then passed to operation 240 and process 200 continues.

In operation 240, an analyst makes a note of the confusion of the system. For example, the system may have confused the words “three thousand” and “breakout”. “Three thousand” is identified as an anti-word of “breakout” and so on for other negative examples of keywords that are detected and this confusion is then noted. The process 200 ends.

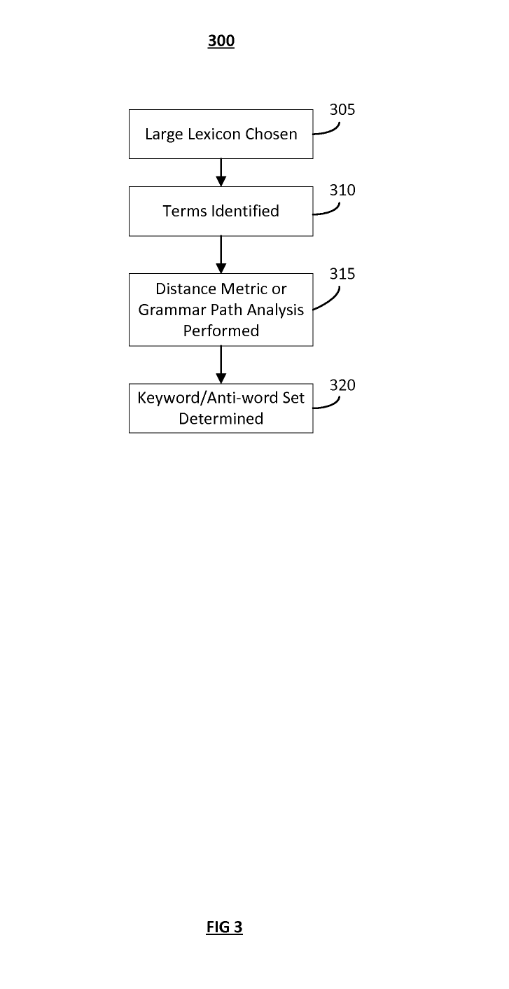

As illustrated in FIG. 3, one embodiment of a process 300 for automatically determining negative examples of keywords suggestions is provided. The process 300 may be operative in step 235 of FIG. 2.

In operation 305, a large lexicon of words is chosen. For example, a large number, such as twenty thousand, of words may be selected. However, any number of words may be chosen such that the number chosen would encompass a majority of terms spoken by people in the identified application domain. Without analysts to listen, terms specifically related to an industry, such as the insurance industry for example, can be targeted. An identified domain may include any domain such as the insurance industry or a brokerage firm, for example. Control is passed to operation 310 and process 300 continues.

In operation 310, keywords are defined. The terms contained in gigabytes of information are then identified to determine a distance metric from one word to another word. Control is passed to operation 315 and process 300 continues.

In operation 315, a specified keyword is compared to domain specific words. For example, a specified keyword may be compared to the identified domain specific words and the closest confusable words to that keyword are then selected from the large lexicon of words. This may be performed using a Phonetic Distance Measure or a Grammar Path Analysis. For example, what a close match constitutes may be defined as the minimum edit distance based on phonological similarity. This metric is augmented with information specific to the model of speech sounds encoded in the recognition system.

Phonetic distance measure is most commonly used in a keyword spotting type application; however, the use of the phonetic distance measure to determine anti-words is a unique approach to building an anti-word set. The Keyword Spotter has a pre-defined set of words that must be listened to in order to try and identify in a stream of audio. Any word can happen anywhere. In a grammar based system, the Keyword Spotter speaks to a predefined syntax. A grammar can be defined that says the world “call” can be followed by a type of 7 digit numbers of a first name or a first and last name combination. This is more constrained than specifying that a digit can happen anytime/anywhere since there has to be a number preceded by the word “call” in this situation.

A grammar constrains what type of sentences can be spoken into the system or alternatively, what type of sentences the system expects. The same confusion or phonetic distance analysis can be done and applied to a grammar. Once a grammar has been defined, a set of sentences can be exhaustively generated that can be parsed by that grammar. A limited number of sentences are obtained. The system then uses the keyword of interest and examines whether that keyword occurs in a similar location throughout the text as other words. The system examines whether these other words may be confused with or sound similar to this keyword. If so, then these words become a part of the anti-word set for this particular keyword.

Following are some examples of a description of phonetic distance measure in regards to FIG. 3.

### Example 1

### The Phonetic Distance within the Words “Cat” and “Bat”

CAT->k ae t

BAT->b ae t

If it is assumed that a score of 1 for every phoneme that is different results and a score of 0 for a perfect match, then for this example the score is 1 since only one phoneme (k<->b) is different.

### Example 2

### The Phonetic Distance Between Words that have a Different Number of Phonemes—“Cat” and “Vacate”

CAT->x x k ae t

VACATE:->w ah k ey t

If it is assumed that insertion of a phoneme costs 1 and the distance between “ae” and “ey” is 0.3, then the total distance between the words is 2.3. The distance between “ae” and “ey” may be the distance between the statistical models stored as a collection in the Acoustic Model 120 (FIG. 1).

### Example 3

### The Phonetic Distance Between Words that have Different Number of Phonemes and Errors Including Insertions, Deletions, and Substitution of Phonemes: “Cat” and “Fall”

CAT: k ae t x

AFT: x ae f t

If it is assumed that the insertion of phonemes costs 1, deletion costs 2, and distance between phonemes “t” and “f” is 0.7, then the total distance between the two words is 3.7. This score accounts for one insertion, one deletion and one substitution of the phonemes.

In another embodiment, a method may be utilized in which the system automatically searches through a large word-to-pronunciation dictionary in a given language to find words that are similar to one another. For users preferring to manually enter the anti-words instead of utilizing automatic suggestions, multiple manual modes of entry may be allowed. The modes may include, for example, the regular spellings of words and/or their phonetic pronunciations.

In operation 320, the keyword anti-word set is determined. For example, domain knowledge about the vocabulary is utilized to determine the anti-words. Those close matching words then become the anti-words for the keyword. There is no human intervention in the selection of the keyword anti-word set. The process 300 ends.

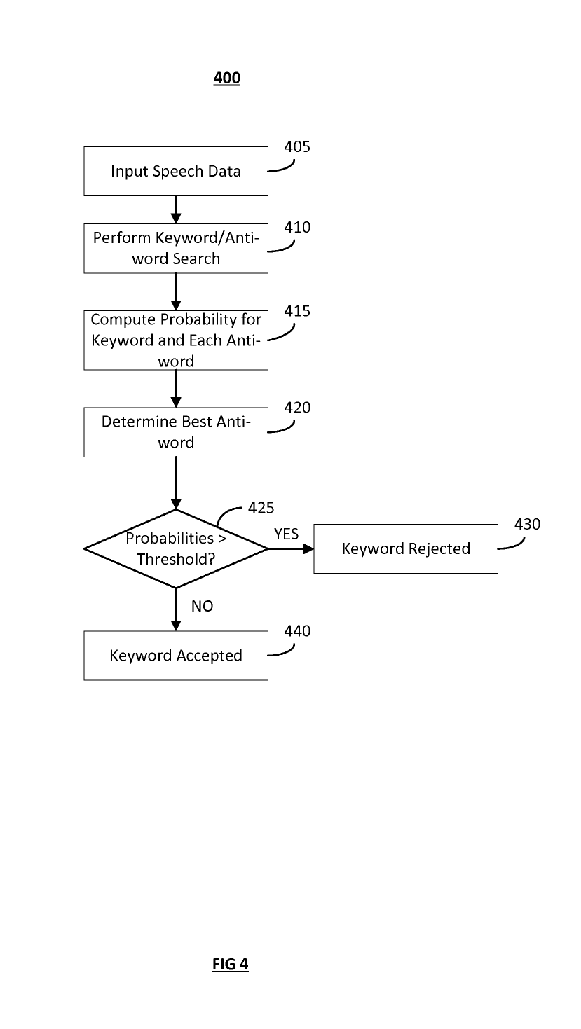

As illustrated in FIG. 4, one embodiment of as process 400 for the use of negative examples of keywords during keyword spotting is presented. The process 400 may be operative in the Pattern Matching within the Recognition Engine 140 of FIG. 1.

In operation 405, speech data is input. For example, speech data, which may include the front end analysis, is input into the keyword search module. Control is passed to operation 410 and the process 400 continues.

In operation 410, as search is performed. For example, as search may be performed for the pattern of the keyword and the anti-word within the speech data. Such pattern may have been determined in the Keyword Model 110 of FIG. 1, for as keyword and a negative example of the keyword. Control is passed to operation 415 and the process 400 continues.

In operation 415, a probability, or confidence value, is computed for the keyword and the anti-words. For example, a probability that the keyword in a particular stream of speech, the anti-words, etc, has been found is computed. Control is passed to operation 420 and the process 400 continues.

In operation 420, the best anti-word is determined. For example, the best anti-word to the keyword may be based on the probability for each word that is determined. Any number of anti-words may be examined as a result of the search and is not limited to the examples shown in FIG. 4.

In operation 425, it is determined whether or not the probability of the keyword is greater than the threshold and whether the probability of the best anti-word is greater than the threshold and whether the overlap with the anti-word is greater than the threshold. If it is determined that the probability of the keyword is greater than the threshold and the probability of the best anti-word is greater than the threshold and that the overlap with the anti-word is greater than the threshold, then control is passed to operation 430 and the process 400 continues. If it is determined that at least one of the conditions is not met, then control is passed to operation 435 and the process 400 continues.

The determination in operation 425 may be made in any suitable manner. For example, the probability of the keyword and the probability of the anti-word are compared with their respective thresholds. If the probability of the keyword is greater than the user defined threshold for that keyword, the probability of the best anti-word is better than an empirically defined anti-word threshold and the keyword and the best anti-word overlap for greater than a predefined percentage of time in the audio stream, then the keyword has been rejected. If the probability of the anti-word for keyword is not greater, then the keyword has been accepted. For example, the anti-word threshold may be set to 0.5 and the time overlap between the keyword and the anti-word for rejection to happen is fifty percent. The probability threshold number is user specified. Thus, (p(KW)≧threshold_{KW}) AND (p(BestAW)≧threshold_{AW}) AND (overlap(KW, BestAW)≧threshold_{OV}), where p is the probability, KW is keyword, and AW is anti-word. If short words are problematic in terms of false positives, then a higher number may be used as a threshold. In one embodiment, for example, a value of 1 may indicate that there is a stricter acoustic match. A value close to 0 might indicate that there is a loose or imprecise match.

In operation 430, the keyword is rejected and the process 400 ends.

In operation 435, the keyword is accepted and the process 400 ends.

More sophisticated schemes to compare keywords and anti-words can be used and are not limited to the examples described above. Negative examples of keywords can be specified through the anti-word search using spelling. The letter sequence or the phonetic spelling can be specified and/or used as a definition. Combinations of human listening and automation can also be used. A lexicon of anti-words that has been determined or suggested automatically can also be added to anti-words that have been determined from human listening in which tags have been determined. In this manner, only common or frequently occurring anti-words are included in the system. The automatic method would determine which confusable words are “common” based on statistics derived from the lexicon of large domain specific data. A human listener would determine anti-words through the listening method and compose the list of anti-words. The words in the lists compiled by the human listener would be validated by the automated system as “common”.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

1. A method for using negative examples of words in a speech recognition system, the method comprising the steps of:
a. defining a set of words;
b. identifying a set of negative examples of said words;
c. performing keyword recognition on said set of words and said set of negative examples;
d. determining confidence values of words in said set of words;
e. determining confidence values of words in said set of negative examples;
f. identifying at least one candidate word from said set of words where said confidence value of words in said set of words meets a first criteria;
g. comparing said confidence value of said at least one candidate word to said confidence value of at least one word in said set of negative examples of words; and,
h. accepting said at least one candidate word as a match if said comparing meets a second criteria.

2. The method of claim 1, wherein step (a) further comprises the steps of:
a.1) collecting recorded conversations from system originations;
a.2) saving said conversations as a searchable database;
a.3) determining a number of keywords for identification within said conversations saved as a searchable database;
a.4) searching for said keywords in said conversations saved as a searchable database;
a.5) identifying keywords within said conversations saved as a searchable database;
a.6) examining said identified keywords;
a.7) detecting negative examples of keywords; and,
a.8) identifying said negative examples of keywords.

3. The method of claim 2, wherein step (a.5) further comprises the step of:
a.5.1) tagging keywords present n said conversations.

4. The method of claim 3, wherein step (a.5.1) further comprising the step of:
a.5.1.1) identifying patterns occurring within said saved conversations of erroneous detection of said keywords.

5. The method of claim 2, wherein step (a.5) further comprises the step of:
a.5.1) noting confusion of the system.

6. The method of claim 1, wherein step (a) further comprises the steps of:
a.1) selecting a large lexicon of words;
a.2) defining a number of keywords;
a.3) determining a distance metric between said keywords;
a.4) comparing specified keywords to said lexicon of words; and,
a.5) selecting at least one closest confusable word to an at least one identified domain specific word from said lexicon of words.

7. The method of claim 6, wherein step (a.1) further comprises the step of:
a.1.1) targeting said lexicon of words to a particular domain.

8. The method of claim 6, wherein step (a.4) further comprises the step of:
a.4.1) performing a phonetic distance measure.

9. The method of claim 6, wherein step (a.4) further comprises the step of:
a.4.1) performing a grammar path analysis.

10. The method of claim 6, wherein step (a.3) further comprises the step of:
a.3.1) searching a word-to-pronunciation dictionary in a given language for words with similar pronunciations.

11. The method of claim 1 wherein step (b) further comprises the step of:
b.1) manually entering negative examples of keywords.

12. The method of claim 1, wherein step (a) further comprises the steps of:
a.1) inputting speech data;
a.2) performing a search;
a.3) computing a confidence value for a keyword and at least one negative example of said keyword;
a.4) determining a best negative example of said keyword;
a.5) determining if a confidence value meets a criteria;
a.6) rejecting said keyword if the confidence value does not meet said criteria.

13. The method of claim 12, wherein step (a.5) further comprises the steps of:
a.5.1) determining if said confidence value of the keyword meets said criteria;
a.5.2) determining if said confidence value of the best negative example of the keyword meets a criteria; and
a.5.3) determining if a confidence value of an overlap with a negative example of the keyword meets a criteria.

14. The method of claim 13, wherein step (a.5.3) further comprises the step of:
a.5.3.1) determining said overlap with a predefined percentage of time a negative example of the keyword appears in an audio stream.

15. A method for using negative examples of words in a speech recognition system, the method comprising the steps of:
a. defining a set of words;
b. performing a first keyword recognition with said set of words;
c. determining confidence values of words in said set of words;
d. identifying at least one candidate word from said set of words where said confidence value of words in said set of words meets a first criteria;
e. selecting a set of negative examples of said at least one candidate word;
f. performing a second keyword recognition with said set of negative examples;
g. determining confidence values of words in said set of negative examples;
h. comparing said confidence value of said at least one candidate word to said confidence value of at least one word in said set of negative examples; and,
i. accepting said at least one candidate word as a match if said comparing meets a second criteria.

16. The method of claim 15, wherein step (a) further comprises the steps of:
a.1) collecting recorded conversations from system originations;
a.2) saving said conversations as a searchable database;
a.3) determining a number of keywords for identification within said conversations saved as a searchable database;
a.4) searching for said keywords in said conversations saved as a searchable database;
a.5) identifying keywords within the conversations saved as a searchable database;
a.6) examining said identified keywords;
a.7) detecting negative examples of keywords; and,
a.8) identifying said negative examples of keywords.

17. The method of claim 16, wherein step (a.5) further comprises the step of:
a.5.1) tagging keywords present in said conversations.

18. The method of claim 17, further comprising the step of:
a.5.1.1) identifying patterns occurring within said saved conversations of erroneous detection of said keywords.

19. The method of claim 18, further comprising the step of:
a.5.1.1.1) noting confusion of the system.

20. The method of claim 15, wherein step (a) further comprises the steps of:
a.1) selecting a large lexicon of words;
a.2) defining a number of keywords;
a.3) determining a distance metric between said keywords;
a.4) comparing specified keywords to said lexicon of words; and,
a.5) selecting at least one closest confusable word to an at least one identified domain specific word from the lexicon of words.

21. The method of claim 20, wherein step (a.1) further comprises the step of:
a.1.1) targeting said lexicon of words to a particular domain.

22. The method of claim 20, wherein step (a.4) further comprises the step of:
a.4.1) performing a phonetic distance measure.

23. The method of claim 20, wherein step (a.4) further comprises the step of:
a.4.1) performing a grammar path analysis.

24. The method of claim 20, wherein step (a.3) further comprises the step of:
a.3.1) searching through a word-to-pronunciation dictionary in a given language for words with similar pronunciations.

25. The method of claim 15, wherein step (e) further comprises the step of:
e.1) manually entering negative examples of keywords.

26. The method of claim 15, wherein step (a) further comprises the steps of:
a.1) inputting speech data;
a.2) performing a search;
a.3) computing a confidence value for a keyword and at least one negative examples of said keyword;
a.4) determining a best negative example of said keyword;
a.5) determining if a confidence value meets a criteria;
a.6) rejecting said keyword if the confidence value meets a criteria.

27. The method of claim 26, wherein step (a.5) further comprises the steps of:
a.5.1) determining if said confidence value of the keyword meets a criteria;
a.5.2) determining if said confidence value of the best negative example of the keyword meets a criteria; and
a.5.3) determining if said confidence value of an overlap with a negative example of the keyword meets a criteria.

28. The method of claim 27, wherein step (a.5.3) further comprises the step of:
a.5.3.1) determining said overlap with a predefined percentage of time a negative example of the keyword appears in an audio stream.

29. The method of claim 15, wherein step (i) further comprising the step of:
i.1) performing the acceptance where said second criteria includes the temporal proximity of recognition of said candidate word to recognition of said words in said set of negative examples.

30. A system for identifying negative examples of keywords comprising:
a. a means for detecting a keyword in an audio stream;
b. a means for detecting a negative example of said keyword in an audio stream;
c. a means for combining information from said detected keyword and detected negative examples of said keyword; and,
d. a means for determining whether a detected word is a negative example of a keyword.
